(19) United States
(12) Patent Application Publication
(10) Pub. No.: US 2016/0320790 A1
(43) Pub. Date: Nov. 3, 2016

(54) CURRENT MIRROR WITH TUNABLE MIRROR RATIO

(71) Applicant: Macronix International Co., Ltd., Hsinchu (TW)

(72) Inventor: Hsien Hung WU, Hsinchu City (TW)

(73) Assignee: Macronix International Co., Ltd.

(21) Appl. No.: 14/698,935

(22) Filed: Apr. 29, 2015

(51) Int. Cl. G05F 3/26

(52) U.S. Cl. CPC G05F 3/267

(57) ABSTRACT

A current mirror circuit includes a current source for generating a reference current, a mirror circuit having a first node for passing a first mirroring current and a second node for passing a second mirroring current, a feedback circuit coupled to the mirror circuit for equalizing voltages on the first and second nodes, and a tunable element coupled to the mirror circuit and driven by an output of the feedback circuit for providing a target output current.

### FIELD OF THE DISCLOSURE

The present disclosure relates to a current mirror and, more particularly, to a current mirror with tunable mirror ratio.

### BACKGROUND OF THE DISCLOSURE

Current mirrors are widely used in analog integrated circuits. A current mirror generates an output current that mirrors a reference current. It is desirable to tune a mirror ratio between the output current and the reference current such that the output current has a precise value.

### SUMMARY

According to an embodiment of the disclosure, a current mirror circuit includes a current source for generating a reference current, a mirror circuit having a first node for passing a first mirroring current and a second node for passing a second mirroring current, a feedback circuit coupled to the mirror circuit for equalizing voltages on the first and second nodes, and a tunable element coupled to the mirror circuit and driven by an output of the feedback circuit for providing a target output current.

According to another embodiment of the disclosure, a method for generating a target output current by a current mirror includes providing a current mirror including a current source for generating a reference current, a mirror circuit having a first node for passing a first mirroring current and a second node for passing a second mirroring current, a feedback circuit coupled to the mirror circuit for equalizing voltages on the first and second nodes, and a tunable element coupled to the mirror circuit and driven by an output of the feedback circuit for providing the target output current.

According to a further embodiment of the disclosure, a current mirror circuit includes a current source for generating a reference current, a mirror circuit having a first node for passing a first mirroring current and a second node for passing a second mirroring current, a feedback circuit coupled to the mirror circuit for equalizing voltages on the first and second nodes, and an output transistor coupled to the mirror circuit and driven by an output of the feedback circuit for providing an output current.

The accompanying drawings, which are incorporated in and constitute a part of this specification, illustrate disclosed embodiments and, together with the description, serve to explain the disclosed embodiments.

### BRIEF DESCRIPTION OF THE DRAWINGS

FIG. 1 schematically illustrates a circuit diagram of a conventional current mirror circuit according to an illustrated embodiment.

FIG. 2 is a computer simulation result of mirroring characteristics of the conventional current mirror circuit of FIG. 1.

FIG. 3 schematically illustrates a circuit diagram of a current mirror circuit according to an illustrated embodiment.

FIG. 4 is a computer simulation result of mirroring characteristics of the current mirror circuit of FIG. 3.

FIG. 5 schematically illustrates a circuit diagram of a current mirror circuit according to an illustrated embodiment.

FIG. 6A is a graph illustrating a relationship between an offset voltage and a drain-source current of a PMOS transistor in the current mirror circuit of FIG. 5, according to an embodiment.

FIG. 6B is a graph illustrating an error in the relationship illustrated in FIG. 6A.

FIG. 7 schematically illustrates a circuit diagram of a current mirror circuit according to an illustrated embodiment.

FIG. 8 is a computer simulation result of temperature compensation characteristics of the current mirror circuit of FIG. 7.

FIG. 9 schematically illustrates a circuit diagram of a current mirror circuit according to an illustrated embodiment.

FIG. 10 is a computer simulation result of temperature compensation characteristics of the current mirror circuit of FIG. 9.

FIG. 11 is a computer simulation result of temperature compensation characteristics of the current mirror circuit of FIG. 9, when a room temperature reference current shifts.

FIG. 12 schematically illustrates a circuit diagram of a current mirror circuit according to an illustrated embodiment.

FIG. 13 is a computer simulation result of temperature compensation characteristics of the current mirror circuit of FIG. 12, when a room temperature reference current shifts.

FIG. 14 schematically illustrates a circuit diagram of a current mirror circuit according to an illustrated embodiment.

### DETAILED DESCRIPTION

Reference will now be made in detail to the present embodiments, examples of which are illustrated in the accompanying drawings. Wherever possible, the same reference numbers will be used throughout the drawings to refer to the same or like parts.

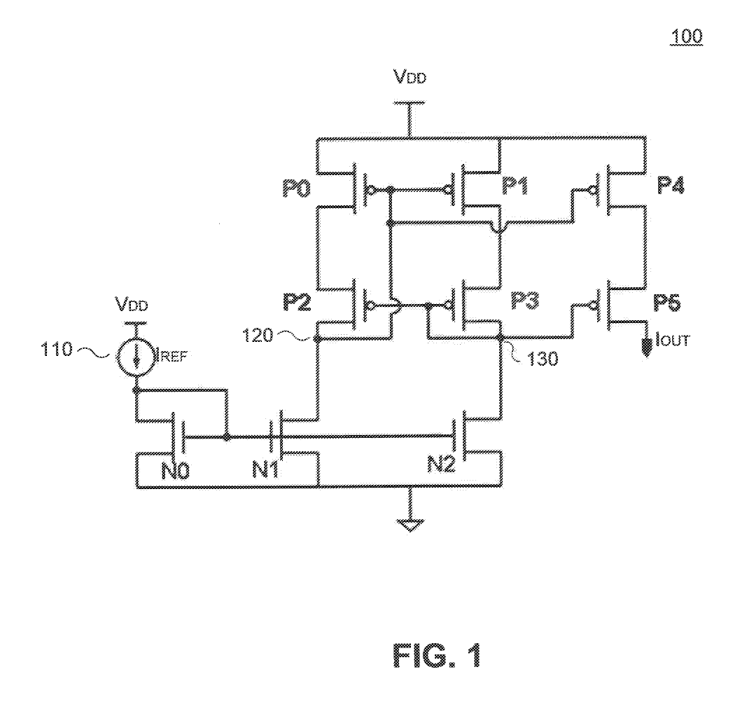

FIG. 1 schematically illustrates a circuit diagram of a conventional current mirror circuit 100 (hereinafter referred to as “circuit 100”), according to an illustrated embodiment. Circuit 100 includes a current source 110, N-type metal-oxide-semiconductor (NMOS) transistors N0 to N2, and P-type metal-oxide-semiconductor (PMOS) transistors P0 to P5, NMOS transistor N0 includes a drain terminal coupled to receive a reference current I_{REF} generated by current source 110, a gate terminal coupled to the drain terminal, and a source terminal coupled to receive a reference voltage (e.g., ground.) NMOS transistor N1 includes a drain terminal coupled to a node 120, a gate terminal coupled to the gate terminal of NMOS transistor NO, and a source terminal coupled to ground. NMOS transistor N2 includes a drain terminal coupled to a node 130, a gate terminal coupled to the gate terminal of NMOS transistor NO, and a source terminal coupled to ground. PMOS transistor P0 includes a source terminal coupled to receive a supply voltage V_{DD}, a gate terminal coupled to node 120, and a drain terminal coupled to PMOS transistor P2. PMOS transistor P1 includes a source terminal coupled to receive the supply voltage V_{DD}, a gate terminal coupled to node 120, and a drain terminal coupled to PMOS transistor P3. PMOS transistor P2 includes a source terminal coupled to the drain terminal of PMOS transistor P0, a gate terminal coupled to node 130, and a drain terminal coupled to node 120. PMOS transistor P3 includes a source terminal coupled to the drain terminal of PMOS transistor P1, a gate terminal coupled to node 130, and a drain terminal coupled to node 130. PMOS transistor P4 includes a source terminal coupled to receive the supply voltage V_{DD}, a gate terminal coupled to node 120, and a drain terminal coupled to PMOS transistor P5, PMOS transistor P5 includes a source terminal coupled to the drain terminal of PMOS transistor P4, a gate terminal coupled to node 130, and a drain terminal coupled to an external circuit (not shown) for outputting an output current I_{OUT}.

In circuit 100, each one of NMOS transistors N0 to N2 and PMOS transistors P0 to P5 has a gate width-to-length (W/L) ratio of 10 μm/10 μm and an M factor of 1 As used herein, the “M factor” is the number of unit transistor elements connected in parallel for a transistor.

Ideally, all of NMOS transistors N0 to N2 and PMOS transistors P0 to P5 work in a saturation region. In the saturation region, a drain-source current I_{DS} of a transistor is determined by,

$${I}_{DS} = \frac{1}{2} μ {C}_{ox} M \frac{W}{L} {( {V}_{GS} - {V}_{TH} )}^{2} \qquad ( 1 )$$

where V_{GS} is the gate-source voltage of the transistor, V_{TH} is the threshold voltage of the transistor, μ is the charge-carrier mobility, Cₒₓ is the gate oxide capacitance per unit area, M is the M factor, W is the gate width, and L is the gate length.

Thus, when all of NMOS transistors N0 to N2 and PMOS transistors P0 to P5 work in a saturation region, because the gate-source voltages V_{GS} of NMOS transistors N0 to N2 are the same, the drain-source currents I_{DS} of NMOS transistors NO to N2 are the same. Similarly, because the gate source voltages V_{GS} of PMOS transistors P0, P1, and P4 are the same, the drain-source currents I_{DS} of PMOS transistors P0, P1, and P4 are the same. The drain-source currents I_{DS} of PMOS transistors P2, P3, and P5 are the same as the drain-source currents I_{DS} of PMOS transistors P0, P1, and P4, respectively. As a result, each one of NMOS transistors N0 to N2 and PMOS transistors P0 to P5 has a drain-source current I_{DS} equal to reference current I_{REF}. Thus, the output current I_{OUT} of circuit 100 is the same as the reference current I_{REF}. Accordingly, a mirror ratio of circuit 100, i.e., the ratio between the output current I_{OUT} and the reference current I_{REF}, is 1:1.

However, when the reference current I_{REF} is small, e.g., in the order of micro-amperes or even smaller, PMOS transistors P0 to P4 may leave the saturation region and enter into a linear region. In the linear region, a drain-source current I_{DS} of a transistor is determined by,

$${I}_{DS} = μ CoxM \frac{W}{L} {V}_{DS} ( {V}_{GS} - {V}_{TH} - \frac{{V}_{DS}}{2} ) \qquad ( 2 )$$

According to Equation (2), in the linear region, the drain-source current I_{DS} not only relates to the gate-source voltage V_{GS}, but also relates to the drain-source voltage V_{DS}. As a result, a difference between V_{DS}_{_}_{P0} of PMOS transistor P0 and V_{DS}_{_}_{P4} of PMOS transistor P4 may result in a difference between I_{DS}_{_}_{P0} of PMOS transistor P0 and I_{DS}_{_}_{P4} of PMOS transistor P4. Such a difference may introduce errors in the mirror ratio of circuit 100.

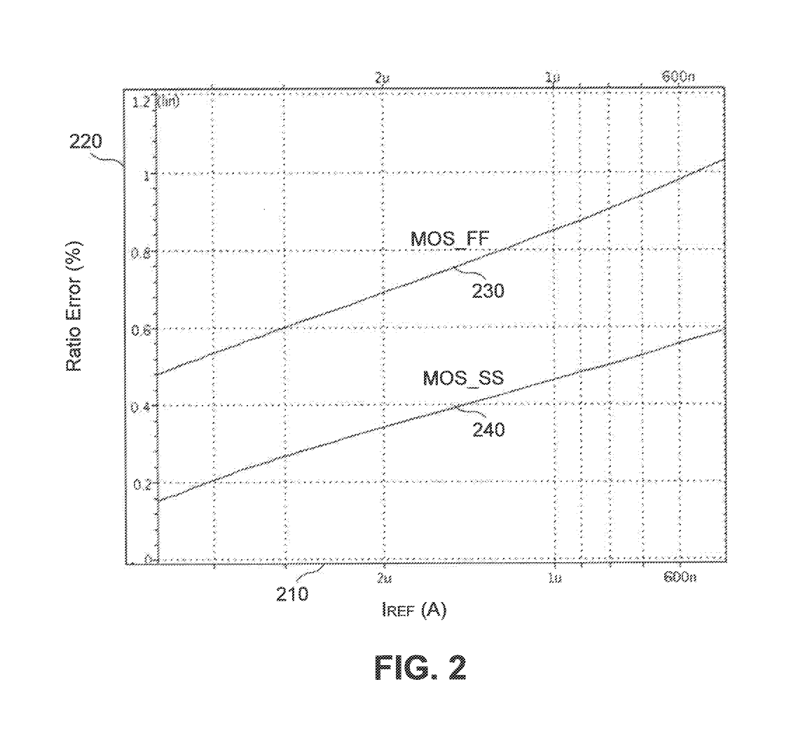

FIG. 2 is a computer simulation result of mirroring characteristics of circuit 100. In the graph of FIG. 2, an abscissa 210 represents the reference current I_{REF} (in A), and an ordinate 220 represents a ratio error (i.e., an error of the mirror ratio as compared to that of the ideal situation). Line 230 represents the ratio error versus I_{REF} of circuit 100 resulting from a simulation using a fast-fast (MOS_FF) corner model. The MOS_FF corner model (hereinafter referred to as “low-V_{TH} skew corner”) assumes that all of the PMOS transistors and NMOS transistors in circuit 100 have been fabricated with the lowest V_{TH}'s. Line 240 represents the ratio error versus I_{REF} of circuit 100 resulting from a simulation using a slow-slow (MOS_SS) corner model. The MOS_SS corner model assumes that all of the PMOS transistors and NMOS transistors in circuit 100 have been fabricated with the highest V_{TH}'s. As illustrated in FIG. 2, when reference current I_{REF} is smaller than 1.24 μA, the ratio error is greater than 0.8% under the low-V_{TH} skew corner model.

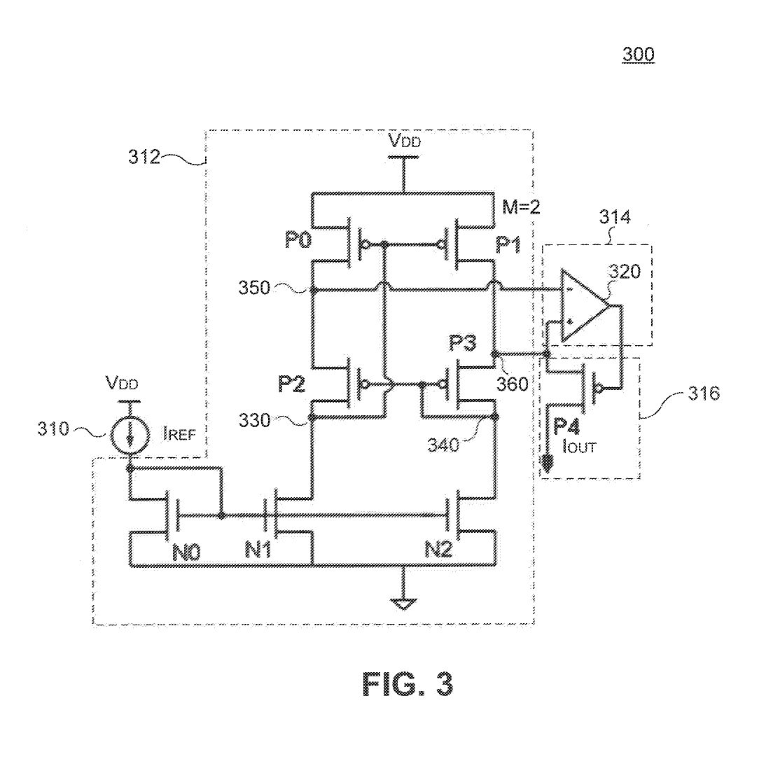

FIG. 3 schematically illustrates a circuit diagram of a current mirror circuit 300 (hereinafter referred to as “circuit 300”), according to an illustrated embodiment. Circuit 300 includes a feedback path that equalizes the drain-source currents of PMOS transistors P0 and P1, and thus reduces the ratio error.

Referring to FIG. 3, circuit 300 includes a current source 310, a mirror circuit 312, a feedback circuit 314, and an output transistor 316. Mirror circuit 312 includes NMOS transistors N0 to N2, and PMOS transistors P0 to P3 which function as mirroring transistors for circuit 300. Feedback circuit 314 includes an operational amplifier 320. Output transistor 316 includes PMOS transistor P4. NMOS transistor NO includes a drain terminal coupled to receive a reference current I_{REF} generated by current source 310, a gate terminal coupled to the drain terminal, and a source terminal coupled to receive a reference voltage (e.g., ground.) NMOS transistor N1 includes a drain terminal coupled to a node 330, a gate terminal coupled to the gate terminal of NMOS transistor NO, and a source terminal coupled to ground. NMOS transistor N2 includes a drain terminal coupled to a node 340, a gate terminal coupled to the gate terminal of NMOS transistor NO, and a source terminal coupled to ground. PMOS transistor P0 includes a source terminal coupled to receive the supply voltage V_{DD}, a gate terminal coupled to node 330, and a drain terminal coupled to a node 350. PMOS transistor P1 includes a source terminal coupled to receive the supply voltage V_{DD}, a gate terminal coupled to node 330, and a drain terminal coupled to node a 360. PMOS transistor P2 includes a source terminal coupled to node 350, a gate terminal coupled to node 340, and a drain terminal coupled to node 330. PMOS transistor P3 includes a source terminal coupled to node 360, a gate terminal coupled to node 340, and a drain terminal coupled to node 340. PMOS transistor P4 includes a source terminal coupled to node 360, a gate terminal coupled to operational amplifier 230, and a drain terminal coupled to an external circuit (not shown) for outputting an output current I_{OUT}. Operational amplifier 320 includes a non-inverting terminal (denoted as “+”) coupled to node 360, an inverting terminal (denoted as “−”) coupled to node 350, and an output terminal coupled to the gate terminal of PMOS transistor P4.

Each one of NMOS transistors N0 to N2 and PMOS transistors P0 to P4 has a W/L ratio of 10 μm/10 μm. The M factor M_{P1} of PMOS transistor P1 is 2. The M factors of the other transistors, i.e., NMOS transistors N0 to N2 and PMOS transistors P0 and P2 to P4, are 1. In some embodiments, PMOS transistor P1 includes two unit transistor elements connected in parallel, while each one of NMOS transistors N0 to N2 and PMOS transistors P0 and P2 to P4 includes only one unit transistor element. In other embodiments, PMOS transistor P1 is fabricated with a gate width W that is twice as large as those of NMOS transistors N0 to N2 and PMOS transistors P0 and P2 to P4.

Operational amplifier 320 and PMOS transistor P4 together constitute a feedback path for circuit 300. Specifically, the non-inverting terminal of operational amplifier 320 is coupled to receive the drain-source voltage V_{DS}_{_}_{P1} of PMOS transistor P1. The inverting terminal of operational amplifier 320 is coupled to receive the drain-source voltage V_{DS}_{_}_{P0} of PMOS transistor P0. Operational amplifier 320 produces an output voltage that drives PMOS transistor P4. The output voltage is proportional to the difference between the drain-source voltage V_{DS}_{_}_{P0} of PMOS transistor P0 and the drain-source voltage V_{DS}_{_}_{P1} of PMOS transistor P1. When V_{DS}_{_}_{P1}>V_{DS}_{_}_{P0}, the output voltage is equal to G·(V_{DS}_{_}_{P1}−V_{DS}_{_}_{P0}), where G is the gain of operational amplifier 320. The output voltage of operational amplifier 320 is applied to the gate terminal of PMOS transistor P4, thereby lowering the voltage at the source terminal of PMOS transistor P4. The output voltage of operational amplifier 320 will be adjusted by the difference between V_{DS}_{_}_{P1} and V_{DS}_{_}_{P0}, until V_{DS}_{_}_{P1}=V_{DS}_{_}_{P0}. As a result, operational amplifier 320 equalizes V_{DS}_{_}_{P1} and V_{DS}_{_}_{P0}.

In operation, node 350 passes a first mirroring current which is the drain-source current I_{DS}_{_}_{P0} of PMOS transistor P0. Because the M factors of transistors N0, N1, P0, and P2 are 1, the first mirroring current is the same as the reference current I_{REF}. In addition, node 360 passes a second mirroring current which is the drain-source current I_{DS}_{_}_{P1} of PMOS transistor P1. When I_{REF} is small, PMOS transistors P0 and P1 work in a linear region, and M_{P1}/M_{P0}=2, according to Equation (2), the second mirroring current is twice as large as the first mirroring current. That is, I_{DS}_{_}_{P1}=2·I_{DS}_{_}_{P0}=2·I_{REF}. Because PMOS transistor P4 is coupled to node 360, the output current I_{OUT} provided by PMOS transistor P4 is related to the second mirroring current. According to Kirchhoffs current law at node 360, the second mirroring current equals the sum of the drain-source current I_{DS}_{_}_{N2} of NMOS transistor N2 and the drain-source current I_{DS}_{_}_{P4} of PMOS transistor P4 (i.e., the output current I_{OUT}). That is, I_{DS}_{_}_{P1}=I_{DS}_{_}_{N2} I_{OUT}. Because I_{DS}_{_}_{N2}=I_{REF}, I_{OUT}=I_{DS}_{_}_{P1}−I_{DS}_{_}_{N2}=I_{REF}. As a result, the output current I_{OUT} is the same as reference current I_{REF}, even when PMOS transistors P0 and P1 work in a linear region.

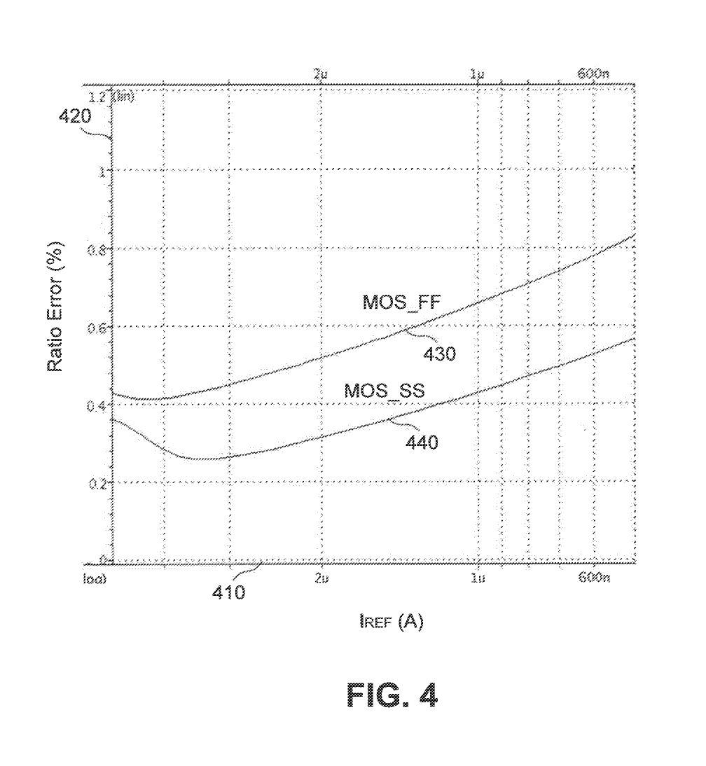

FIG. 4 is a computer simulation result of mirroring characteristics of circuit 300. In the graph of FIG. 4, an abscissa 410 represents reference current I_{REF} (in A), and an ordinate 420 represents a ratio error. Line 430 represents the ratio error versus I_{REF} of circuit 300 resulting from a simulation using the fast-fast (MOS_FF) corner model. Line 440 represents the ratio error versus I_{REF} of circuit 300 resulting from a simulation using the slow-slow (MOS_SS) corner model. As illustrated in FIG. 4, only when reference current I_{REF} is smaller than 550 nA, the ratio error is greater than 0.8% under the low-V_{TH} skew corner model.

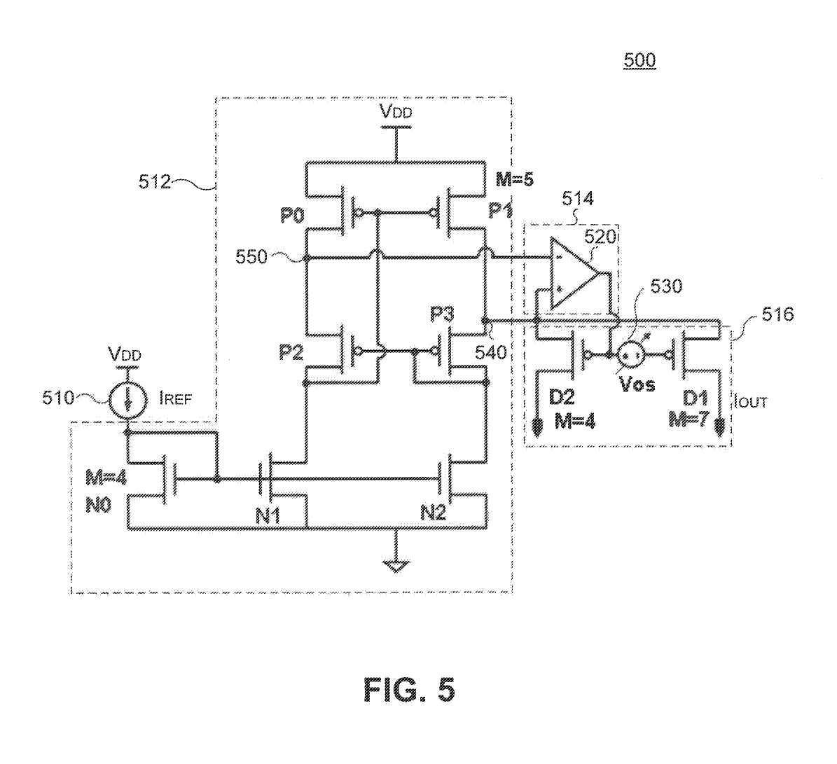

FIG. 5 schematically illustrates a circuit diagram of a current mirror circuit 500 (hereinafter referred to as “circuit 500”), according to an illustrated embodiment. Circuit 500 includes a tunable element within a feedback path, such that a mirror ratio of circuit 500 is tunable to be a target value which is not solely determined by the M-factors of MOS transistors.

Referring to FIG. 5, circuit 500 includes a current source 510, a mirror circuit 512, a feedback circuit 514, and a tunable element 516. Mirror circuit 512 includes NMOS transistors N0 to N2, and PMOS transistors P0 to P3 that function as mirroring transistors for circuit 500. Feedback circuit 514 includes an operational amplifier 520. Tunable element 516 includes PMOS transistors D1, and 02, and an adjustable voltage source 530. PMOS transistors D1 and 02 function as output transistors for circuit 500. The couplings of current source 510, NMOS transistors N0 to N2, PMOS transistors P0 to P3, and operational amplifier 520 are similar to current source 310, NMOS transistors N0 to N2, PMOS transistors P0 to P3, and operational amplifier 320 in circuit 300. Thus, a detailed description of the couplings is not provided.

Comparing to circuit 300, circuit 500 includes tunable element 516 in the place of PMOS transistor P4 of circuit 300. Tunable element 516 is coupled within a feedback path of circuit 500 for providing the target output current. Specifically, operational amplifier 520 includes a non-inverting terminal (denoted as “+”) coupled to a node 540 (which is the source terminal of PMOS transistor P3), an inverting terminal (denoted as “−”) coupled to a node 550 (which is the drain terminal of PMOS transistor P0), and an output terminal coupled to PMOS transistor D2. PMOS transistor D1 includes a source terminal coupled to node 540, a gate terminal coupled to adjustable voltage source 530, and a drain terminal coupled to an external circuit (not shown) for outputting an output current I_{OUT}. PMOS transistor D2 includes a source terminal coupled to node 540, a gate terminal coupled to the output terminal of operational amplifier 520, and a drain terminal coupled to the external circuit. Both of PMOS transistors D1 and D2 are driven by the output of operational amplifier 520. Adjustable voltage source 530 includes a positive terminal (denoted as “+”) coupled to the gate terminal of PMOS transistor D2, and a negative terminal (denoted as “−”) coupled to the gate terminal of PMOS transistor D1.

Each one of NMOS transistors N0 to N2 and PMOS transistors P0 to P3, D1, and D2 has a W/L ratio of 10 μm/10 μm. The M factor M_{N0} of NMOS transistor N0 is 4. The M factor M_{P1} of PMOS transistor P1 is 5. The M factor M_{D1} of PMOS transistor D1 is 7. The M factor M_{D2} of PMOS transistor D2 is 4. The M factors of the other transistors, i.e., NMOS transistors N1 and N2 and PMOS transistors P0, P2, and P3, are 1.

In operation, node 550 passes a first mirroring current which is the drain-source current I_{DS}_{_}_{P0} of PMOS transistor P0, and I_{DS}_{_}_{P0}=I_{REF}/4. Node 540 passes a second mirroring current which is the drain-source current I_{DS}_{_}_{P1} of PMOS transistor P1, and I_{DS}_{_}_{P1}=5I_{REF}/4. According to Kirchhoff's current law at node 540, the second mirroring current equals the sum of the drain-source current I_{DS}_{_}_{N2} of NMOS transistor N2, the drain-source current I_{DS}_{_}_{D1} of PMOS transistor D1 (i.e., output current I_{OUT}), and the drain-source current I_{DS}_{_}_{D2} of PMOS transistor D2. That is, I_{DS}_{_}_{P1}=I_{DS}_{_}_{N2}+I_{DS}_{_}_{D1}+I_{DS}_{_}_{D2}. Because I_{DS}_{_}_{N2}=I_{REF}/4, I_{DS}_{_}_{D1}+I_{DS}_{_}_{D2}=I_{DS}_{_}_{P1}−I_{DS}_{_}_{N2}=5·I_{REF}/4−I_{REF}/4=I_{REF}.

Adjustable voltage source 530 generates an offset voltage V_{OS}, which is applied between the gate-source voltage V_{GS}_{_}_{D2} of PMOS transistor D2 and the gate-source voltage V_{GS}_{_}_{P1} of PMOS transistor D1. The offset voltage V_{OS} can be adjusted to obtain a target output current I_{target}. The relationship between the offset voltage V_{OS} and the target output current I_{target} can be derived as follows.

First, it is assumed that both PMOS transistors D1 and D2 work in a saturation region. Thus, according to Equation (1), for each one of PMOS transistors D1 and D2,

$${V}_{GS} = {V}_{TH} + \sqrt{2 {I}_{DS} / β} \\ where \\ β = μ {C}_{ox} M \frac{W}{L} . \qquad ( 3 )$$

The offset voltage V_{OS} creates a difference between the gate-source voltage V_{GS}_{_}_{D1} of PMOS transistor D1 and the gate-source voltage V_{GS}_{_}_{P2} of PMOS transistor D2. Thus, the offset voltage V_{DS} can be represented by,

$${V}_{OS} = {V}_{GS \_ D 1} - {V}_{GS \_ D 2} = \sqrt{2 \text{/} ( {C}_{ox} W \text{/} L )} \cdot {μ}^{- 1 \text{/} 2} \cdot ( \sqrt{{I}_{DS \_ D 1} \text{/} {M}_{D 1}} - \sqrt{{I}_{DS \_ D 2} \text{/} {M}_{D 2}} ) \qquad ( 4 )$$

In order for the output current (i.e., the drain-source current I_{DS}_{_}_{D1} of PMOS transistor D1) to be equal to I_{target}, I_{DS}_{_}_{D1} should be equal to I_{target}. Because I_{DS}_{_}_{D2}=I_{REF}−I_{DS}_{_}_{D2}=I_{REF}−I_{target}. Accordingly, Equation (4) can be transformed to,

$${V}_{OS} = \sqrt{2 \text{/} ( {C}_{ox} W \text{/} L )} \cdot {μ}^{- 1 \text{/} 2} \cdot ( \sqrt{{I}_{target} \text{/} {M}_{D 1}} - \sqrt{( {I}_{REF} - {I}_{target} ) \text{/} {M}_{D 2}} ) \qquad ( 5 )$$

Therefore, by adjusting V_{OS} according to Equation (5), circuit 500 can generate a target output current I_{target}. For example, when I_{REF}=12.6 μA, V_{OS} can be adjusted such that the output current I_{OUT}=I_{target}=10 μA with the arrangement of tunable element 516 described above. Thus, a desired mirror ratio can be achieved by tuning the offset voltage V_{OS}.

In circuit 500, the M factors of PMOS transistors D1 and D2 are not limited to 7 and 4, respectively, and can be any integer value depending on an application of circuit 500. When the M factors of PMOS transistors D1 and D2 change, the offset voltage V_{OS} needs to be adjusted accordingly.

In circuit 500, the polarity of adjustable voltage source 530 (i.e., the coupling of the positive and negative terminals of adjustable voltage source 530 in circuit 500) is determined based on the reference current I_{REF}, the target output current I_{target}, and the M factors of PMOS transistors D1 and D2. If

$${I}_{target} > {I}_{REF} \cdot \frac{{M}_{DI}}{{M}_{DI} + {M}_{D 2}} ,$$

then the positive terminal of adjustable voltage source 530 is coupled to the gate terminal of PMOS transistor D2, and the negative terminal of adjustable voltage source 530 is coupled to the gate terminal of PMOS transistor D1, as illustrated in FIG. 5. On the other hand, if,

$${I}_{target} < {I}_{REF} \cdot \frac{{M}_{DI}}{{M}_{DI} + {M}_{D 2}} ,$$

then the polarity of adjustable voltage source 530 is reversed. That is, the positive terminal of adjustable voltage source 530 is coupled to the gate terminal of PMOS transistor D1, and the negative terminal of adjustable voltage source 530 is coupled to the gate terminal of PMOS transistor D2. If

$${I}_{target} = {I}_{REF} \cdot \frac{{M}_{D 1}}{{M}_{D 1} + {M}_{D 2}} ,$$

then the output current I_{DS}_{_}_{D1} is the target output current I_{target}. In this case, the offset voltage V_{OS} to be generated by the adjustable voltage source 530 is zero. As a result, the polarity of adjustable voltage source 530 can be configured in either way described above.

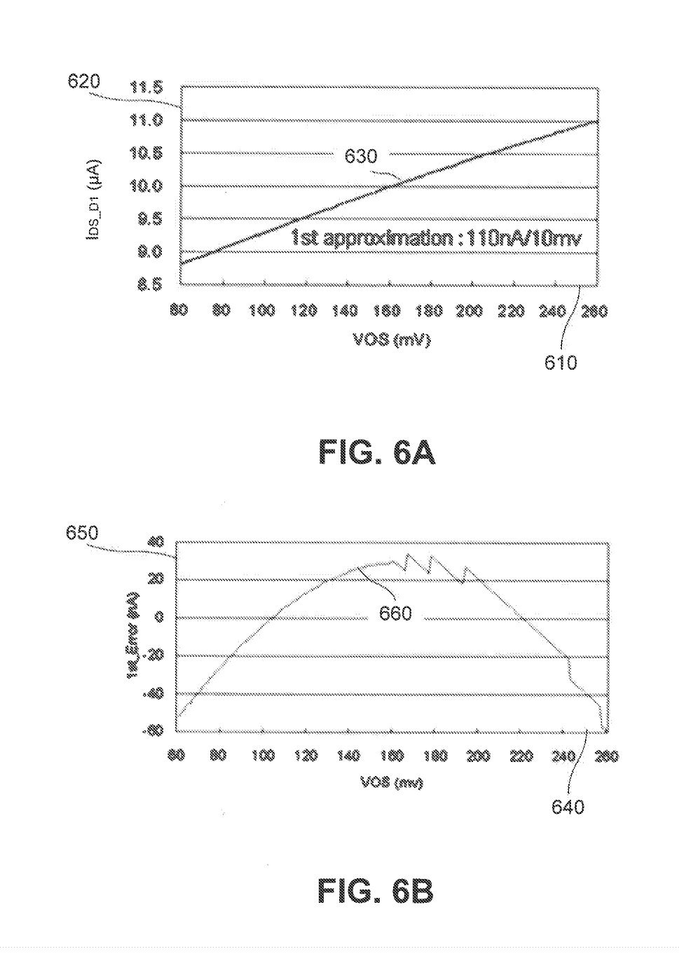

FIG. 6A is a graph illustrating a relationship between the offset voltage V_{OS} and the drain-source current I_{DS}_{_}_{D1} of PMOS transistor D1, according to an embodiment. In the graph of FIG. 6A, an abscissa 610 represents the offset voltage V_{OS} (in mV), and an ordinate 620 represents the drain-source current I_{DS}_{_}_{D1} (in ρA) of PMOS transistor D1. Line 630 represents the relationship between the offset voltage Vas and the drain-source current I_{DS}_{_}_{D1} of PMOS transistor D1, the relationship being obtained by a first-order linear approximation. FIG. 6B is a graph illustrating an error of the first-order linear approximation of the relationship between offset voltage V_{OS} and the drain-source current I_{DS}_{_}_{D1} of PMOS transistor D1, according to an embodiment. In the graph of FIG. 6B, an abscissa 640 represents the offset voltage V_{OS} (in mV), and an ordinate 650 represents the error of the drain-source current I_{DS}_{_}_{D1} (in nA) obtained by the first-order linear approximation. Line 660 represents the relationship between the offset voltage V_{OS} and the error of the drain-source current I_{DS}_{_}_{D1} of PMOS transistor D1 obtained by the first-order linear approximation.

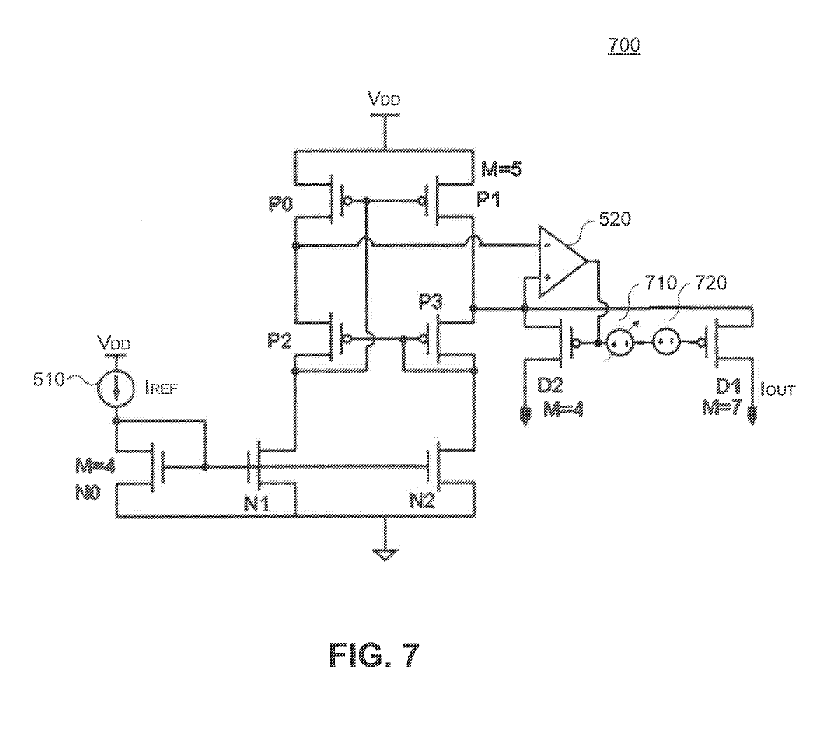

FIG. 7 schematically illustrates a circuit diagram of a current mirror circuit 700 (hereinafter referred to as “circuit 700”), according to an illustrated embodiment. Circuit 700 includes a temperature dependent voltage source, such that an output current I_{OUT} of circuit 700 is temperature independent. That is, the output current I_{OUT} does not vary with an operation temperature of circuit 700, i.e., the temperature of circuit 700 when circuit 700 is operating.

Referring to FIG. 7, circuit 700 includes current source 510, NMOS transistors N0 to N2, PMOS transistors P0 to P3, D1, and D2, an operational amplifier 520, that are similar to the components of circuit 500. Different from circuit 500, circuit 700 includes a temperature independent voltage source 710 and a temperature dependent voltage source 720 between the gates of PMOS transistors D1 and D2. Temperature independent voltage source 710 generates a room temperature offset voltage, which is adjustable to obtain a target output current at room temperature. Temperature dependent voltage source 720 generates a temperature dependent voltage, which is used to compensate for a variation of the output current due to a temperature variation between the room temperature and the operation temperature of circuit 700.

In circuit 700, current source 510 is a temperature independent source. That is, I_{REF} generated by current source 510 does not vary with the operation temperature of circuit 700. However, some device parameters of the transistors of circuit 700, such as the threshold voltage V_{TH} and the charge-carrier mobility p, may vary with the operation temperature. Without the temperature dependent voltage source 720, even when the output current I_{OUT} reaches a target value at room temperature, the output current I_{OUT} may drift away from the target value when the operation temperature drifts away from the room temperature. In order to keep I_{OUT} temperature independent, temperature dependent voltage source 720 generates the temperature dependent voltage to compensate for the variation of process parameters of the transistors due to the temperature variation. The relationship between the room temperature offset voltage, the temperature dependent voltage, and the operation temperature T can be derived as follows.

First, the charge-carrier mobility p is temperature dependent, which can be represented by,

μ=μ₀·(T/T₀)^{-α} (6)

where T₀ is the room temperature, μ₀ is the charge-carrier mobility when the operation temperature is the room temperature T₀, μ is the charge-carrier mobility at the operation temperature T, and α is the mobility temperature exponent of the charge-carrier mobility μ for MOS transistors of a given technology.

The charge-carrier mobility μ can be approximated by using first-order Taylor expansion, such that,

μ=μ₀(T/T₀)^{-α}=μ₀(1+ΔT/T₀)^{-α}

μ^{-1/2}=μ₀^{-1/2}·(1+ΔT/T₀)≈μ₀^{-1/2}·[1+(α/2T₀)·T] (7)

where ΔT=T−T₀.

Combining Equations (4) and (7) results in,

$${V}_{OS} = \sqrt{2 \text{/} ( {C}_{ox} W \text{/} L )} \cdot {μ}_{0}^{- 1 \text{/} 2} \cdot [ 1 + ( α \text{/} 2 {T}_{0} ) \cdot Δ T ] \cdot ( \sqrt{{I}_{DS \_ D 1} \text{/} {M}_{D 1}} - \sqrt{{I}_{DS \_ D 2} \text{/} {M}_{D 2}} ) \qquad ( 8 )$$

where V_{OS} is the offset voltage generated by the combination of temperature independent voltage source 710 and temperature dependent voltage source 720.

Assume a target drain-source current of PMOS transistor D1 (i.e., the target output current of circuit 700) at room temperature is I₁₀, and a drain-source current of PMOS transistor D2 at room temperature is I₂₀. That is, at room temperature, I_{DS}_{_}_{D1}=I₁₀, and I_{DS}_{_}_{D2}=I₂₀. Let \sqrt{I₁₀/M_{D1}}=B₁, and \sqrt{I₂₀/M_{D2}}=B₂. Then, Equation (8) can be written as,

V_{OS}=\sqrt{2/(CₒₓW/L)}·μ₀^{-1/2}·[1+(α/2T₀)·ΔT]·(B₁−B₂) (9)

The offset voltage V_{OS} can be represented by a room temperature offset voltage V_{OS0} and a temperature coefficient TC, as

V_{OS}=V_{OS0}·(1+TC·ΔT) (10)

where V_{OS0} is the room temperature offset voltage generated by temperature independent voltage source 710, V_{OS0}·TC·ΔT is the temperature dependent voltage generated by temperature dependent voltage source 720, and TC is a temperature coefficient for the offset voltage V_{OS}.

Comparing Equations (9) and (10), the room temperature offset voltage V_{OS0} and the temperature coefficient TC can be represented by,

V_{OS0}={square root over (2/(CₒₓW/L)}·μ₀^{-1/2}·(B₁−B₂) (11)

TC=α/2T₀ (12)

According to Equation (11), for a given reference current I_{REF}, the room temperature offset voltage V_{OS0} is determined according to Equation (11) to obtain a given target output current I₁₀ at room temperature. That is, the room temperature offset voltage V_{OS0} is determined based on the target output current I₁₀, the reference current I_{REF}, the gate oxide capacitance per unit area Cₒₓ, the width-to-length ratio W/L, and the room temperature charge-carrier mobility μ₀. In one embodiment consistent with the disclosure, when determining the room temperature offset voltage V_{OS0}, it is assumed that both of Cₒₓ and μ₀ do not vary with device fabrication processes, i.e., Cₒₓ and μ₀ are consistent across various process corners, such as a MOS_TT corner (in which all of the NMOS transistors and PMOS transistors have typical V_{TH}'s between the highest V_{TH}'s and the lowest V_{TH}'s,) a MOS_FF corner (in which all of the NMOS transistors and PMOS transistors have the lowest V_{TH}'s,) a MOS_SS corner (in which all of the PMOS transistors and NMOS transistors have the highest V_{TH}'s,) a MOS_FS corner (in which all of the NMOS transistors have the lowest V_{TH}'s, and all of the PMOS transistors have the highest V_{TH}'s,) and a MOS_SF corner (in which all of the NMOS transistors have the highest V_{TH}'s, and all of the PMOS transistors have the lowest V_{TH}'s.) Once the room temperature offset voltage V_{OS0} is determined, the room temperature offset voltage V_{OS0} is fixed and does not vary with temperature during the operation of circuit 700. In addition, because the temperature coefficient TC is independent of temperature variation according to Equation (12), the term V_{OS0}·TC·does not vary with temperature either. Thus, during the operation of circuit 700, the only variable in the offset voltage V_{OS}=V_{OS0}+V_{OS0}·TCΔT is the temperature difference ΔT between the operation temperature T and the room temperature T₀. Therefore, the offset voltage V_{OS} that varies with the temperature difference ΔT can be used to compensate for the variation of process parameters of the transistors due to the temperature variation.

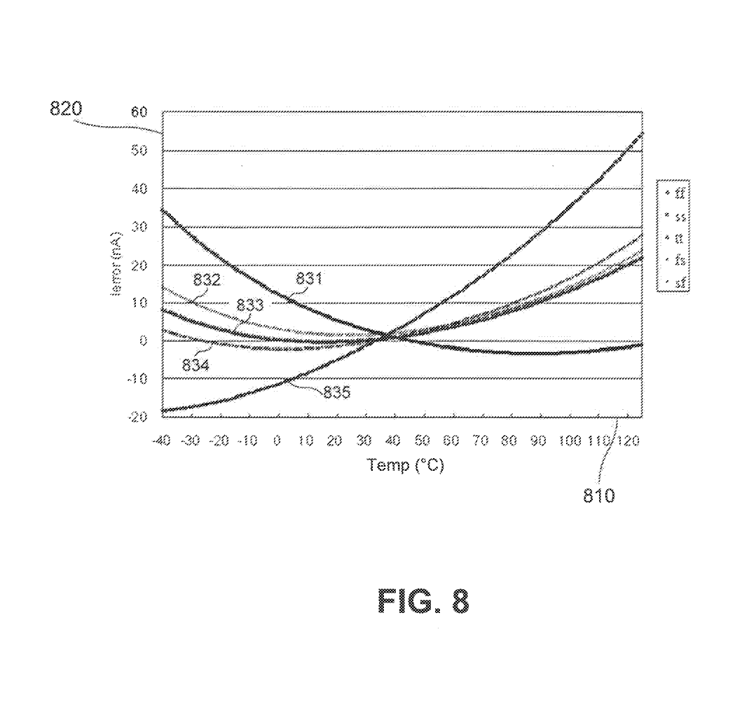

FIG. 8 is a computer simulation result of temperature compensation characteristics of circuit 700. In the graph of FIG. 8, an abscissa 810 represents the operation temperature T (in degrees C.), and an ordinate 820 represents an output current error Iₑᵣᵣₒᵣ (in nA) between the actual output current I_{OUT} and the target output current I₁₀. Curve 831 represents the output current error Iₑᵣᵣₒᵣ versus operation temperature (hereinafter referred to as “temperature compensation error”) resulting from a simulation using the slow-slow (MOS_SS) corner model, which assumes that all of the PMOS transistors and NMOS transistors in circuit 700 have the highest V_{TH}'s. Curve 832 represents the temperature compensation error resulting from a simulation using a fast-slow (MOS_FS) corner model, which assumes that all of the NMOS transistors have the lowest V_{TH}'s, and all of the PMOS transistors have the highest V_{TH}'S. Curve 833 represents the temperature compensation error resulting from a simulation using a typical-typical (MOS_TT) corner model, which assumes that all of the NMOS transistors and PMOS transistors have typical V_{TH}'s between the highest V_{TH}'s and the lowest V_{T j}'s. Curve 834 represents the temperature compensation error resulting from a simulation using a slow-fast (MOS_SF) corner model, which assumes that all of the NMOS transistors have the highest V_{TH}'s, and all of the PMOS transistors have the lowest V_{TH}'s. Curve 835 represents the temperature compensation error resulting from a simulation using the fast-fast (MOS_FF) corner model, which assumes that all of the NMOS transistors and PMOS transistors have the lowest V_{TH}'s.

During the simulations to produce the results illustrated in FIG. 8, I_{REF} is set to be 12.6 μA and V_{OS0} is determined according to Equation (11) to meet Iₒᵤₜ=I₁₀=10 uA at T₀, which is the middle of a temperature simulation range for each process corner. In addition, the temperature dependent voltage V_{OS0}·TC·ΔT is assumed to not be adjustable. When determining V_{OS0} for the MOS_FF corner, the MOS_SS corner, the MOS_FS corner, and the MOS_SF corner, parameters including Cox and μ in the typical-typical (MOS_TT) corner model are utilized as the Cox and μ for the these four corners. However, such determined temperature dependent voltage V_{OS0}·TC·ΔT does not track process variations of the PMOS and NMOS transistors. That is, device parameters such as Cox and μ vary with device fabrication processes, and are different in different process corners, such as the MOS_FF corner, the MOS_SS corner, the MOS_FS corner, and the MOS_SF corner. The differences of Cox and μ in these process corners may result in variations of the temperature compensation error across these process corners. As a result, as illustrated in FIG. 8, curves 831 to 835 each representing the temperature compensation error at a respective process corner, are different. For example, when the operation temperature is 120° C., the temperature compensation error resulting from the MOS_FF corner model is nearly doubled compared to the temperature compensation errors resulting from the other corner models. As another example, when the operation temperature is −40° C., the temperature compensation error resulting from the MOS_SS corner model is the highest compared to the temperature compensation error resulting from the other corner models.

During the simulations to produce the results illustrated in FIG. 8, both of Cox and μ vary across process corners. However the present disclosure is not limited thereto. If only Cox varies across process corners but p does not, the temperature dependent voltage V_{OS0}·TC·ΔT determined based on the MOS_TT corner model still cannot track process variations. Thus, the temperature compensation errors across these process corners are different, [Inventor: Claim 6 is revised. Please let us know whether revised claim 6 covers what you intended to claim.]

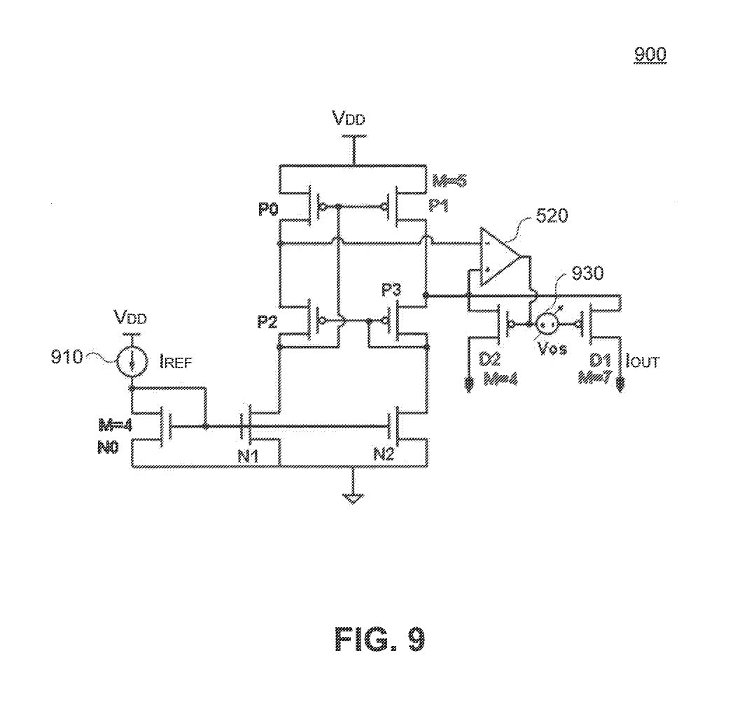

FIG. 9 schematically illustrates a circuit diagram of a current mirror circuit 900 (hereinafter referred to as “circuit 900”), according to an illustrated embodiment. Circuit 900 includes a temperature dependent current source for compensating for the temperature variation.

Referring to FIG. 9, circuit 900 includes a current source 910, NMOS transistors N0 to N2, PMOS transistors P0 to P3, D1, and D2, operational amplifier 520, and a voltage source 930. The couplings of current source 910, NMOS transistors NO to N2, PMOS transistors P0 to P3, D1, and D2, operational amplifier 520, and voltage source 930 of circuit 900 are similar to those of the similar components of circuit 500. Each one of NMOS transistors N0 to N2 and PMOS transistors P0 to P3, D1, and D2 has a W/L ratio of 10 μm/10 μm. The M factor M_{N0} of NMOS transistor N0 is 4. The M factor M_{P1} of PMOS transistor P1 is 5. The M factor M_{D1} of PMOS transistor D1 is 7. The M factor M_{D2} of PMOS transistor D2 is 4. The M factors of the other transistors, i.e., NMOS transistors N1, N2, and PMOS transistors P0 P2, and P3, are 1.

In circuit 900, current source 910 is a temperature dependent current source, which generates a reference current I_{REF} that changes as the operation temperature T changes. Voltage source 930 is a temperature independent voltage source, which generates an offset voltage V_{OS} that does not change as the operation temperature T changes. In order to keep I_{OUT} temperature independent, current source 910 is configured to provide the reference current I_{REF} that is adjustable based on the operation temperature T to compensate for the variation of process parameters of the transistors due to the temperature variation. The relationship between the reference current I_{REF} and the operation temperature T can be derived as follows.

First, assume that the temperature dependent reference current I_{REF} can be represented by,

I_{REF}=I₀[1+ΔT·TC] (13)

where I₀ is the reference current at room temperature T₀, I₀·ΔT·TC is a temperature dependent part of the reference current I_{REF}, ΔT=T−T₀, and TC is a temperature coefficient for I_{TEF}.

At room temperature, I_{DS}_{_}_{D1}=I₁₀, I_{DS}_{_}_{D2}=I₂₀, and I_{REF}=I_{DS}_{_}_{D1}+I_{DS}_{_}_{D2}=I₁₀+I₂₀. Thus, I_{DS}_{_}_{D2} can be represented by,

$$\begin{matrix}{I}_{DS \_ D 2} = {I}_{REF} - {I}_{10} \\ = {I}_{0} [ 1 + Δ T \cdot TC ] - {I}_{10} \\ = {I}_{0} - {I}_{10} + {I}_{0} Δ T \cdot TC \\ = {I}_{20} + {I}_{0} Δ T \cdot TC\end{matrix} \qquad ( 14 )$$

Combining Equations (4) and (14), the offset voltage V_{OS} can be represented by,

$$\begin{matrix}{V}_{OS} = {V}_{GS \_ D 1} - {V}_{GS \_ D 2} \\ = \sqrt{2 / ( {C}_{ox} W / L )} \cdot {μ}^{- 1 / 2} \cdot [ \sqrt{{I}_{DS \_ D 1} / {M}_{D 1}} - \sqrt{{I}_{DS \_ D 2} / {M}_{D 2}} ] \\ = \sqrt{2 / ( {C}_{ox} W / L )} \cdot {μ}^{- 1 / 2} \cdot [ \sqrt{{I}_{10} / {M}_{D 1}} - \sqrt{( {I}_{REF} - {I}_{10} ) / {M}_{D 2}} ] \\ = \sqrt{2 / ( {C}_{ox} W / L )} \cdot {μ}^{- 1 / 2} \cdot \\ [ \sqrt{{I}_{10} / {M}_{D 1}} - \sqrt{( {I}_{20} + {I}_{0} \cdot TC \cdot Δ T ) / {M}_{D 2}} ] \\ = \sqrt{2 / ( {C}_{ox} W / L )} \cdot {μ}^{- 1 / 2} \cdot \\ [ \sqrt{{I}_{10} / {M}_{D 1}} - \sqrt{{I}_{20} / {M}_{D 2}} \sqrt{1 + ( {I}_{0} \cdot TC \cdot Δ T ) / {I}_{20}} ] \\ ≅ \sqrt{2 / ( {C}_{ox} W / L )} \cdot {μ}^{- 1 / 2} \cdot \\ [ \sqrt{{I}_{10} / {M}_{D 1}} - \sqrt{{I}_{20} / {M}_{D 2}} ( 1 + ( {I}_{0} \cdot TC \cdot Δ T ) / ( 2 \cdot {I}_{20} ) ) ] \\ = \sqrt{2 / ( {C}_{ox} W / L )} \cdot {μ}^{- 1 / 2} \cdot [ {B}_{1} - {B}_{2} ( 1 + ( {I}_{0} \cdot Δ T \cdot TC ) / ( 2 \cdot {I}_{20} ) ) ] \\ = \sqrt{2 / ( {C}_{ox} W / L )} \cdot {μ}^{- 1 / 2} \cdot [ ( {B}_{1} - {B}_{2} ) - ( {B}_{2} {I}_{0} / 2 \cdot {I}_{20} ) \cdot Δ T \cdot TC ]\end{matrix} \qquad ( 15 )$$

where B₁=\sqrt{I₁₀/M_{D1}}, and B₂=\sqrt{I₂₀/M_{D2}}.

Combining Equations (7) and (15), the offset voltage V_{OS} can be represented by,

$$\begin{matrix}{V}_{OS} \approx \sqrt{2 / ( {C}_{ox} W / L )} \cdot {μ}_{0}^{- 1 / 2} \cdot [ 1 + ( α / 2 {T}_{0} ) \cdot Δ T ] \cdot \\ [ ( {B}_{1} - {B}_{2} ) - ( {B}_{2} {I}_{0} / 2 \cdot {I}_{20} ) \cdot Δ T \cdot TC ] \\ = \sqrt{2 / ( {C}_{ox} W / L )} \cdot {μ}_{0}^{- 1 / 2} \cdot ( {B}_{1} - {B}_{2} ) \\ [ 1 + ( α / 2 {T}_{0} ) \cdot Δ T ] \cdot [ 1 - ( {B}_{2} {I}_{0} / 2 \cdot {I}_{20} \cdot ( {B}_{1} - {B}_{2} ) ) \cdot Δ T \cdot TC ]\end{matrix} \qquad ( 16 )$$

In order to render the offset voltage V_{OS} temperature independent, the first-order ΔT dependent terms in Equation (16) need to be cancelled. In order to cancel the first-order ΔT dependent terms in Equation (16), the temperature coefficient TC can be set as,

$$TC = \frac{( {B}_{1} - {B}_{2} ) \cdot {I}_{20}}{{B}_{2} \cdot {I}_{0}} \cdot \frac{α}{{T}_{0}} \qquad ( 17 )$$

As a result, the offset voltage V_{OS} can be represented by,

V_{OS}=\sqrt{2/(CₒₓW/L)}·μ₀^{-1/2}·(B₁−B₂) (18)

Thus, in circuit 900, the reference current I_{REF} can be determined according to Equations (13) and (17), and the offset voltage V_{OS} can be determined according to Equation (18). As seen in Equations (13) and (17), I_{REF} includes a temperature independent current I₀ for producing the target output current at room temperature, and a temperature dependent current I₀·ΔT·TC for temperature compensation.

Similar to circuit 700 of FIG. 7, current source 910 can be implemented by a temperature independent current source and a temperature dependent current source. The temperature independent current source generates the reference current I₀ at room temperature T₀. The temperature dependent current source generates the temperature dependent current I₀·ΔT·TC.

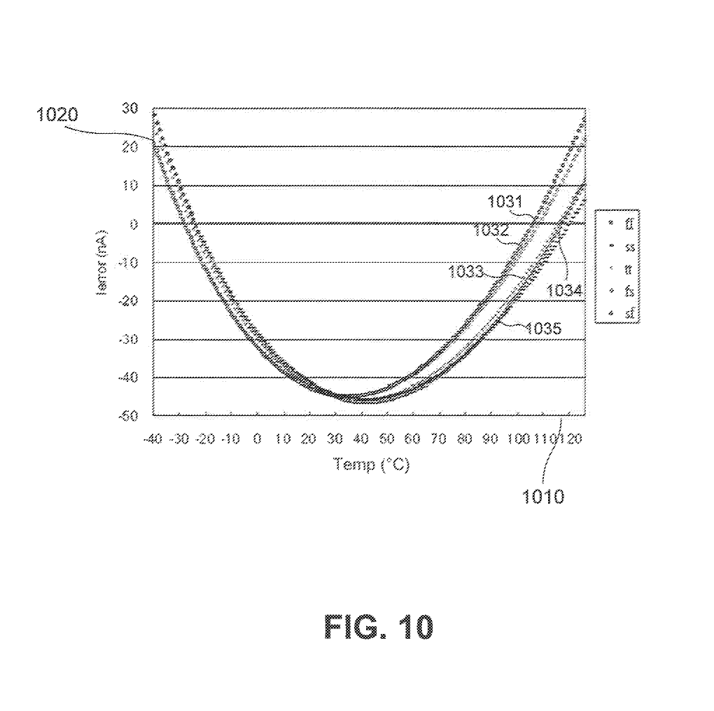

FIG. 10 is a computer simulation result of temperature compensation characteristics of circuit 900. In the graph of FIG. 10, an abscissa 1010 represents the operation temperature T (in degrees C.), and an ordinate 1020 represents an output current error between the actual output current I_{OUT} (in nA) and the target output current I₁₀. Curve 1031 represents the temperature compensation error resulting from a simulation using the fast-fast (MOS_FF) corner model. Curve 1032 represents the temperature compensation error resulting from a simulation using the fast-slow (MOS_FS) corner model. Curve 1033 represents the temperature compensation error resulting from a simulation using the typical-typical (MOS_TT) corner model. Curve 1034 represents the temperature compensation error resulting from a simulation using the slow-fast (MOS_SF) corner model. Curve 1035 represents the temperature compensation error resulting from a simulation using the slow-slow (MOS_SS) corner model.

During the simulation to produce the results illustrated in FIG. 10, the room temp reference current I₀ is set to be 12.6 uA and the offset voltage V_{OS} is determined based on Equation (18) to meet Iₒᵤₜ=I₁₀=10 uA at the middle of a temperature simulation range for each process corner. Also, the temperature dependent current I₀·ΔT·TC is assumed to not be adjustable. According to Equation (17), the temperature coefficient TC of I_{REF} is independent of Cox and μ, but only relates to known parameters such as B1, B2, I₀, I₂₀, T₀ and α. That is, the temperature dependent part I₀·ΔT·TC of I_{REF} is less sensitive to process variations. As a result, as illustrated in FIG. 10, the temperature compensation error does not vary with different process corners as much as those in FIG. 8. Thus, circuit 900 including the temperature dependent current source 910 reduces the variation of temperature compensation error in different process corners.

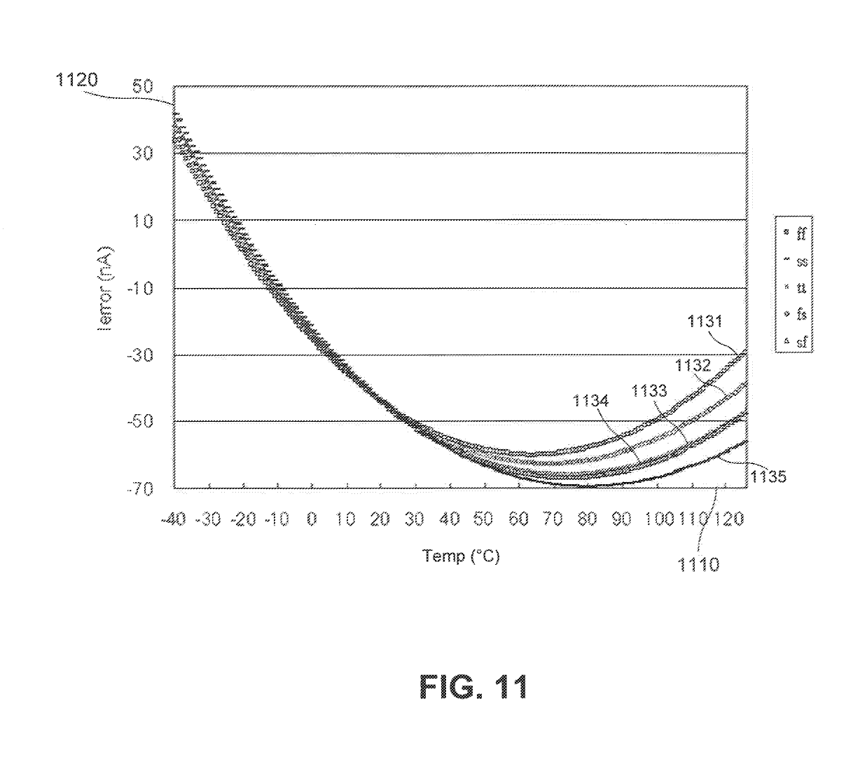

FIG. 11 is a computer simulation result of temperature compensation characteristics of circuit 900, when the room temperature reference current I_{c}) shifts to become I₀′=90%·I₀. In the graph of FIG. 11, an abscissa 1110 represents the operation temperature T (in degrees C.), and an ordinate 1120 represents an output current error Iₑᵣᵣₒᵣ=I_{OUT}−I₁₀ (in nA), where I₁₀ is 10 μA, and I_{OUT} is obtained when I_{REF} is determined based on Equations (13) and (17), with TC in Equation (17) being determined based on the original I₀=12.6 μA, and I₀ in Equation (13) being I₀′=90%·I₀. Curve 1131 represents the temperature compensation error resulting from a simulation using the fast-fast (MOS_FF) corner model. Curve 1132 represents the temperature compensation error resulting from a simulation using the fast-slow (MOS_FS) corner model. Curve 1133 represents the temperature compensation error resulting from a simulation using the typical-typical (MOS_TT) corner model. Curve 1134 represents the temperature compensation error resulting from a simulation using the slow-fast (MOS_SF) corner model. Curve 1135 represents the temperature compensation error resulting from a simulation using the slow-slow (MOS_SS) corner model.

When I₀=12.6 uA shifts to I₀′=90%·I₀=11.3 uA, I₀′ is larger than the target output current I₁₀=10 μA. Although the polarity of Vos, the values of I₁₀, and B₁ in Equations (17) and (18) are all unchanged, the value of I₂₀ now shifts from I₂₀=I₀−I₁₀=2.6 uA to I₂₀′=I₀′−I₁₀=1.3 uA, which makes B₂′ (=\sqrt{I₂₀′/M_{D2}}) smaller. Considering the deviation of I₂₀′ and B₂′ in Equations (17) and (18), both the ideal

$${TC}^{′} ( = \frac{( {B}_{1} - {B}_{2}^{′} ) \cdot {I}_{20}^{′}}{{B}_{2}^{′} \cdot {I}_{0}^{′}} \cdot \frac{α}{{T}_{0}} )$$

and Vos′ (=\sqrt{2/(CₒₓW/L)}·μ₀^{-1/2}·(B₁−B₂′)) for I₀′ should be higher than original TC and Vos for I₀. This explains the negative trend of Ierror in FIG. 11 when temperature changes from −40° C. to 40° C. Finally, the differences between the values of lerror across the five corners increase when the temperature increases to 125° C.

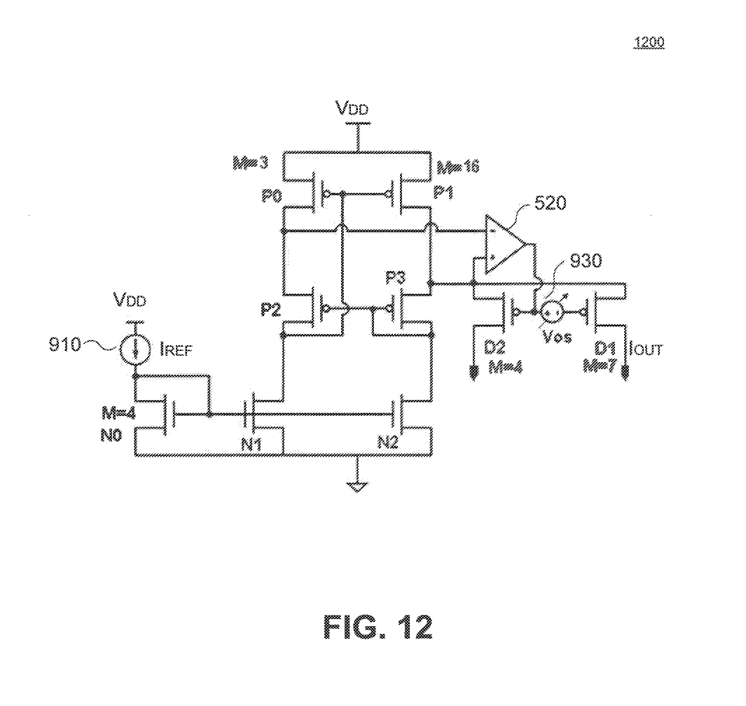

FIG. 12 schematically illustrates a circuit diagram of a current mirror circuit 1200 (hereinafter referred to as “circuit 1200”), according to an illustrated embodiment. Circuit 1200 includes PMOS transistors P0 and P1 with adjusted M factors for compensating for a shifting of I₀.

Referring to FIG. 12, circuit 1200 includes current source 910, NMOS transistors N0 to N2, PMOS transistors P0 to P3, D1 and D2, operational amplifier 520, and voltage source 930, that are similar to the components of circuit 900. Unlike circuit 900, the M factor Mₚ₀ of PMOS transistor P0 is 3, and the M factor M_{P1} of PMOS transistor P1 is 16.

Circuit 1200 is applied in a situation when the room temperature reference current I₀ shifts to become I₀′=90%·I₀. As explained previously, when I₀ shifts to become I₀′=90%·I₀, the temperature dependent part of Iref also shifts by a 90% factor. This results in temperature compensation error across different process corners, especially at high temperature region. However, in circuit 1200, the ratio of M_{P1}/M_{P0} is adjusted to become 16/3 instead of 5/1 so that the shifted current I₀′ is enlarged 1.083 (=(16/3−1)/4) times. As a result, 1.083 I₀′ is equivalent to 97.49% (=1.083×0.9) of original I₀.

In circuit 1200, the M factors of PMOS transistors P0 and P1 are 3 and 16, respectively. However, the present disclosure is not limited thereto, and the M factors of PMOS transistors P0 and P1 are determined based on the shifting of the room temperature reference current I₀. For example, in order to adjust the M factors of PMOS transistors P0 and P1, circuit 1200 can include a MOS switch (not shown) connected to each one of PMOS transistors P0 and P1. When shifting of I₀ is detected, the MOS switches can adjust the M factors of PMOS transistors P0 and P1 based on the shifting of I₀.

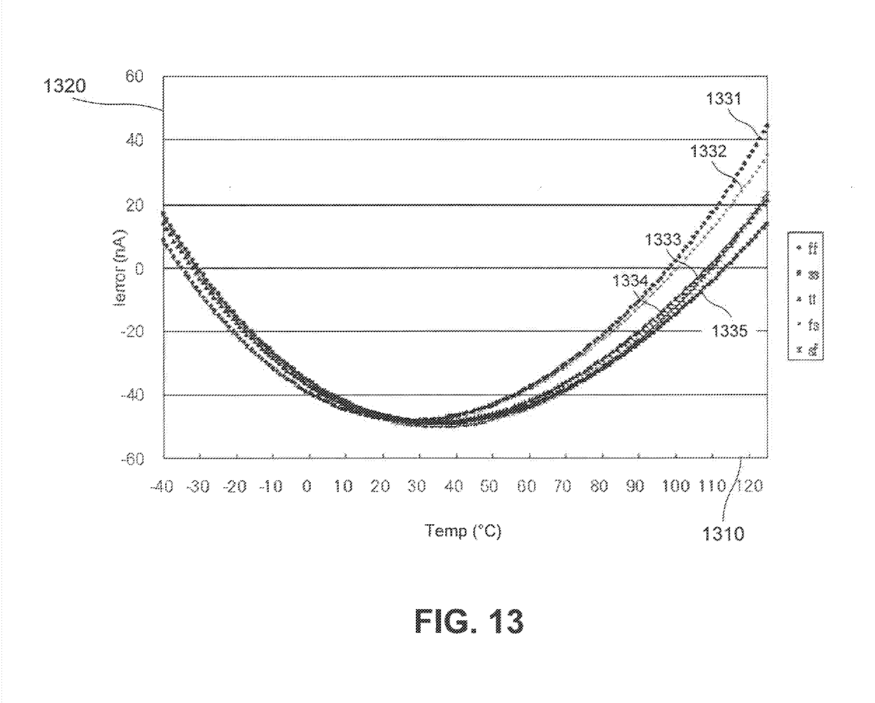

FIG. 13 is a computer simulation result of temperature compensation characteristics of circuit 1200, when the room temperature reference current I₀ shifts to become I₀′=90%·I₀. In the graph of FIG. 13, an abscissa 1310 represents the operation temperature T (in degrees C.), and an ordinate 1320 represents an output current error Iₑᵣᵣₒᵣ=I_{OUT}−I₁₀ (in nA), where I₁₀ is 10 μA, and I_{OUT} is obtained when I_{REF} is determined based on Equations (13) and (17), with TC in Equation (17) being determined based on the original I₀=12.6 μA, and I₀ in Equation (13) being I₀′=90%·I₀. Curve 1331 represents the temperature compensation error resulting from a simulation using the fast-fast (MOS_FF) corner model. Curve 1332 represents the temperature compensation error resulting from a simulation using the fast-slow (MOS_FS) corner model. Curve 1333 represents the temperature compensation error resulting from a simulation using the typical-typical (MOS_TT) corner model. Curve 1334 represents the temperature compensation error resulting from a simulation using the slow-fast (MOS_SF) corner model. Curve 1335 represents the temperature compensation error resulting from a simulation using the slow-slow (MOS_SS) corner model.

As explained previously, in circuit 1200, because the M factors of PMOS transistors P0 and P1 are adjusted to enlarge the shifted I₀′, the output current I_{OUT} remains at I₁₀ even when I₀ shifts. As a result, curves 1331 to 1335 in FIG. 13 are similar to curves 1031 to 1035 in FIG. 10. That is, the values of Ierror at −40° C. and at 125° C. across five corners are closer to each other in FIG. 13 compared with those in FIG. 11. For example, the maximum difference between Ierror at −40° C. and at 125° C. is reduced from 97.82 nA in FIG. 11 to 36.22 nA in FIG. 13.

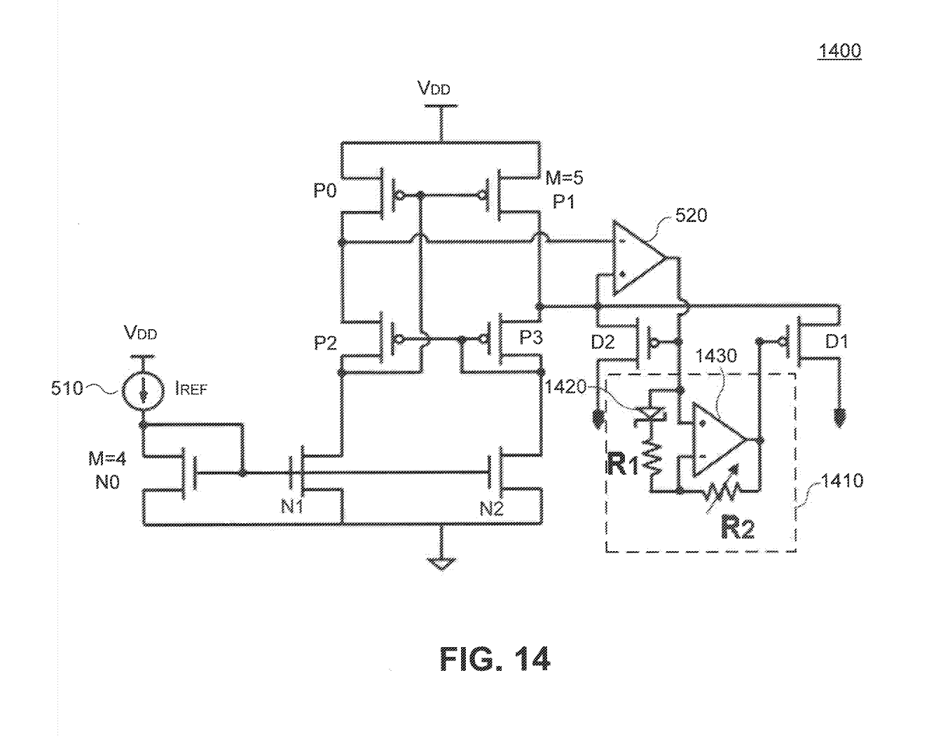

FIG. 14 schematically illustrates a circuit diagram of a current mirror circuit 1400 (hereinafter referred to as “circuit 1400”), according to an illustrated embodiment. Circuit 1400 includes a voltage scaling circuit as an implementation of adjustable voltage source 530 of circuit 500.

Referring to FIG. 14, circuit 1400 includes current source 510, NMOS transistors N0 to N2, PMOS transistors P0 to P3, D1, and D2, operational amplifier 520, and a voltage scaling circuit 1410. Current source 510, NMOS transistors N0 to N2, PMOS transistors P0 to P3, D1, and D2, operational amplifier 520 are similar to the similar components of circuit 500 of FIG. 5.

Voltage scaling circuit 1410 is connected between the gate terminal of PMOS transistor D2 and the gate terminal of PMOS transistor D1. Voltage scaling circuit 1410 includes a Zener diode 1420, a first resistor R1, a second resistor R2, and an operational amplifier 1430. Zener diode 1420 includes a first terminal coupled to the gate terminal of PMOS transistor D2, and a second terminal coupled to first resistor R1. First resistor R1 includes a first terminal coupled to the second terminal of Zener diode 1420 and a second terminal coupled to second resistor R2. Second resistor R2 is an adjustable resistor, and includes a first terminal coupled to first resistor R1 and a second terminal coupled to the gate terminal of PMOS transistor D1. Operational amplifier 1430 includes a non-inverting terminal (denoted as “+”) coupled to the gate terminal of PMOS transistor D2, an inverting terminal (denoted as “−”) coupled to the second terminal of first resistor R1, and an output terminal coupled to the gate terminal of PMOS transistor D1.

Voltage scaling circuit 1410 functions as an adjustable voltage source that generates an offset voltage V_{OS} applied between the gate terminals of PMOS transistors D1 and D2. The offset voltage V_{OS} can be represented by,

$${V}_{OS} = - \frac{{R}_{2}}{{R}_{1}} {V}_{z}$$

where R₁ is the resistance of first resistor R1, R₂ is the resistance of second resistor R2, and V_{Z} is the breakdown voltage of Zener diode 1420. Because second resistor R2 is an adjustable resistor, V_{OS} is adjustable by adjusting the resistance of second resistor R2. For example, V_{OS} can be adjusted according to Equation (5), such that the output current I_{OUT} of circuit 1400 can be a target value I_{target}.

Circuits 300, 500, 700, 900, 1200, and 1400 are MOS circuits. However, the present disclosure is not limited to MOS circuits and can be applied to field effect transistor (FET) circuits, bipolar junction transistor (BJT) circuits, and bipolar junction transistor and complementary metal-oxide-semiconductor (BiCMOS) circuits.

The current mirrors of the embodiments of the present disclosure can be applied to a circuit system where a precise source current is desired, such as relaxation oscillator circuits and current comparators, etc.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A current mirror circuit, comprising:
a current source for generating a reference current;
a mirror circuit having a first node for passing a first mirroring current and a second node for passing a second mirroring current;
a feedback circuit coupled to the mirror circuit for equalizing voltages on the first and second nodes; and
a tunable element coupled to the mirror circuit and driven by an output of the feedback circuit for providing a target output current.

2. The current mirror circuit of claim 1, wherein the tunable element includes:
a first output transistor coupled to the second node for outputting the target output current;
a second output transistor coupled to the second node and driven by an output of the operational amplifier, and
an adjustable voltage source coupled between gate terminals of the first and second output transistors for generating an offset voltage to provide the target output current.

3. The current mirror circuit of claim 2, wherein the adjustable voltage source generates the offset voltage based on a charge-carrier mobility, a gate oxide capacitance per unit area, a width-to-length ratio of the first and second output transistors, the target output current, the reference current, and M factors of the first and second output transistors.

4. The current mirror circuit of claim 2, wherein a polarity of the adjustable voltage source is configured based on the target output current, the reference current, and M factors of the first and second output transistors.

5. The current mirror circuit of claim 2, wherein the adjustable voltage source generates a room temperature offset voltage providing the target output current at room temperature, and a temperature dependent offset voltage to compensate for a variation of the output current due to a temperature variation.

6. The current mirror circuit of claim 5, wherein the adjustable voltage source generates the room temperature offset voltage based on a gate oxide capacitance per unit area, a width-to-length ratio of the first and second output transistors, a room temperature charge-carrier mobility, the target output current, the reference current, and M factors of the first and second output transistors, at least one of the gate oxide capacitance per unit area and the room temperature charge-carrier mobility varying across process corners, and
the adjustable voltage source generates the temperature dependent offset voltage based on the room temperature offset voltage, a difference between an operation temperature and a room temperature, and a temperature coefficient which is determined based on a temperature exponent of a charge-carrier mobility and the room temperature.

7. The current mirror circuit of claim 2, wherein the adjustable voltage source generates the offset voltage which is temperature independent, and
the current source generates the reference current which is temperature dependent to compensate for a variation of the output current due to a temperature variation.

8. The current mirror circuit of claim 7, wherein the current source generates a room temperature reference current and a temperature dependent reference current,
the current source generating the temperature dependent reference current based on the room temperature reference current, a difference between an operation temperature and a room temperature, and a temperature coefficient, and
the temperature coefficient being related to a temperature code of a charge-carrier mobility, the room temperature, the reference current, the target output current, the charge-carrier mobility, a gate oxide capacitance per unit area, and M factors of the first and second output transistors.

9. The current mirror circuit of claim 2, wherein the adjustable voltage source is implemented by a voltage scaling circuit.

10. The current mirror circuit of claim 1, wherein the mirror circuit includes a first mirroring transistor coupled to the first node and a second mirroring transistor coupled to the second node,
M factors of the first and second mirroring transistors being configured to compensate for a shifting of the reference current at room temperature.

11. A method for generating a target output current by a current mirror, comprising:
providing a current mirror including:
a current source for generating a reference current;
a mirror circuit having a first node for passing a first mirroring current and a second node for passing a second mirroring current;
a feedback circuit coupled to the mirror circuit for equalizing voltages on the first and second nodes; and
a tunable element coupled to the mirror circuit and driven by an output of the feedback circuit for providing the target output current.

12. The method of claim 11, wherein the providing the current mirror including the tunable element further includes:
providing a first output transistor coupled to the second node for outputting a target output current;
providing a second output transistor coupled to the second node and driven by an output of the operational amplifier; and
providing an adjustable voltage source coupled between gate terminals of the first and second output transistors for generating an offset voltage.

13. The method of claim 12, further including determining the offset voltage based on a charge-carrier mobility, a gate oxide capacitance per unit area, a width-to-length ratio of the first and second output transistors, the target output current, the reference current, and M factors of the first and second output transistors.

14. The method of claim 12, further including configuring a polarity of the adjustable voltage source based on the target output current, the reference current, and M factors of the first and second output transistors.

15. The method of claim 11, further including adjusting the offset voltage to compensate for a variation of the output current due to a temperature variation.

16. The method of claim 15, wherein the adjusting the offset voltage further includes:
adjusting a room temperature offset voltage for providing the target output current at a room temperature; and
adjusting a temperature dependent offset voltage to compensate for a variation of the output current due to the temperature variation.

17. The method of claim 11, further including adjusting the reference current generated by the current source to compensate for a variation of the output current due to a temperature variation.

18. The method of claim 17, wherein the reference current includes a room temperature reference current and a temperature dependent reference current,
the adjusting the reference current including adjusting the temperature dependent reference current based on the room temperature reference current, a difference between an operation temperature and a room temperature, and a temperature coefficient.

19. The method of claim 11, wherein the providing the mirror circuit includes:
providing a first mirroring transistor coupled to the first node;
providing a second mirroring transistor coupled to the second node; and
adjusting M factors of the first and second mirroring transistors to compensate for a shifting of the reference current at room temperature.

20. A current mirror circuit, comprising:
a current source for generating a reference current;
a mirror circuit having a first node for passing a first mirroring current and a second node for passing a second mirroring current;
a feedback circuit coupled to the mirror circuit for equalizing voltages on the first and second nodes; and
an output transistor coupled to the mirror circuit and driven by an output of the feedback circuit for providing an output current.
